(19) United States
(12) Patent Application Publication
(10) Pub. No.: US 2007/0203988 A1
(43) Pub. Date: Aug. 30, 2007

(54) File protection methods and systems

(75) Inventors: Jiunh-Yih Lee, Taipei City (TW); Ming-Ta Hsu, Jhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co. Ltd.

(21) Appl. No.: 11/361,741

(22) Filed: Feb. 24, 2006

(51) Int. Cl. G06F 15/16

(52) U.S. Cl. 709/206

(57) ABSTRACT

A file protection method. At least one file attached to an e-mail is retrieved. An executable file including the attached file is automatically generated. The file attached to the e-mail is automatically replaced by the executable file. The e-mail is transmitted to a destination terminal. When executed, the executable file determines whether to display the attached file based on transmission of the destination terminal identification to a predetermined server.

### BACKGROUND

The invention relates to computer techniques, and in particular, to data protection.

Since e-mails are widely used in business transactions, various documents including confidential files are exchanged thereby. Even if addressees are limited to a specified group, e-mails as well as files therein may be forwarded to others.

Document protection typically uses cryptographic techniques. Thus, only recipient computers with a corresponding key can open encrypted e-mail attachments. Encrypted data is first decrypted before being opened by a corresponding application. Once encrypted data is decrypted to plain data, duplication or distribution thereof may be easily performed. For example, the plain data or a portion thereof may be copied or saved to another file utilizing corresponding functions of the application and forwarded to others.

Additionally, when e-mails with attached files are received, no license agreement is set before the attached files are made available, making prosecution against an infringer difficult.

### SUMMARY

Accordingly, file protection methods and systems are provided.

An exemplary embodiment of a file protection method is implemented in a computer. At least one file attached to an e-mail is retrieved. An executable file including the attached file is automatically generated. The file attached to the e-mail is automatically replaced by the executable file. The e-mail is transmitted to a destination terminal. When executed, the executable file determines whether to display the attached file based on transmission of the destination terminal identification to a predetermined server.

An exemplary embodiment of a file protection method is implemented in a computer. At least one file attached to an e-mail is retrieved. An executable file including the attached file is automatically generated. When opening, the attached file requires an application for processing content thereof. The file attached to the e-mail is automatically replaced by the executable file. When executed, rather than launching the application, the executable file displays the content of the attached file utilizing essential component objects to perform display functions of the application. The executable file prevents implementation of other functions of the application for the file.

An exemplary embodiment of a file protection system comprises a communication interface and a file converter. The communication interface retrieves at least one file attached to an e-mail. The file converter automatically generates an executable file including the attached file and automatically replaces the attached file with the executable file. The communication interface transmits the e-mail to a destination terminal. When executed, the executable file determines whether to display the attached file based on transmission of the destination terminal identification to a predetermined server.

### DESCRIPTION OF THE DRAWINGS

The invention can be more fully understood by reading the subsequent detailed description and examples with references made to the accompanying drawings, wherein:

FIG. 1 is a block diagram of a network.

FIG. 2 is a schematic view of an exemplary embodiment of an email and a file protection system.

FIG. 3 is a flowchart of an exemplary embodiment of a file protection method.

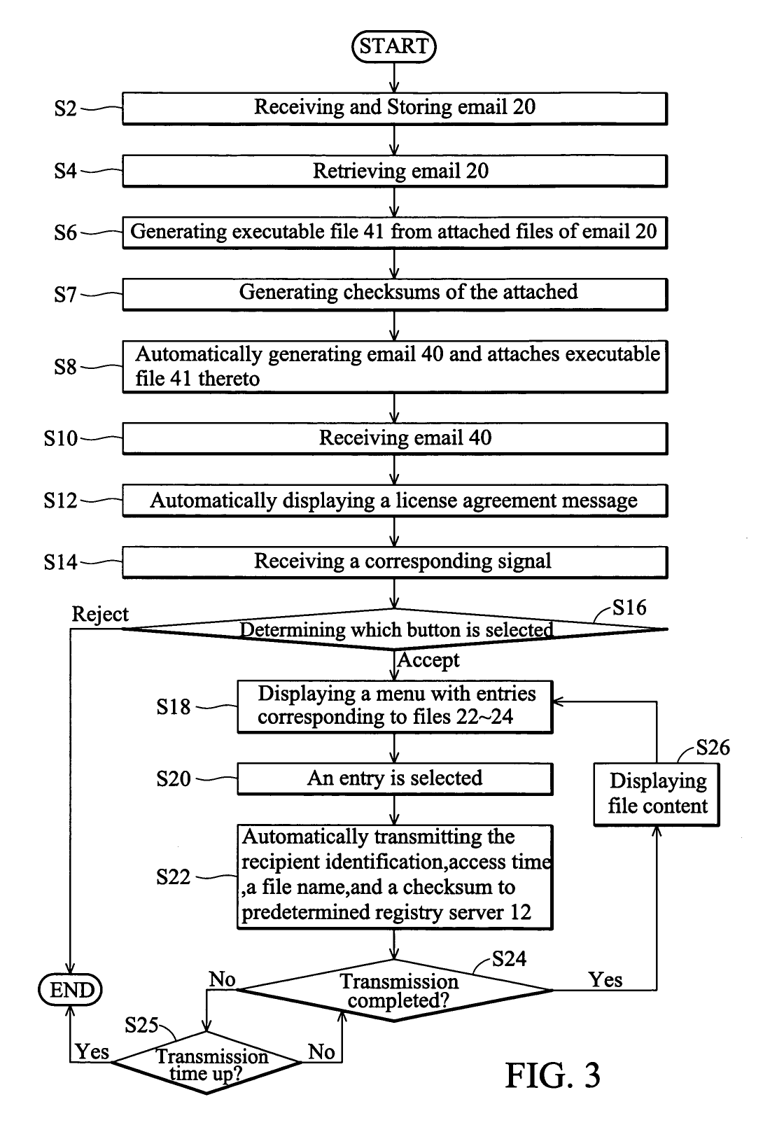

FIG. 4 is a schematic diagram of an exemplary embodiment of an email converted by the file protection system.

FIG. 5 is a schematic diagram of an exemplary embodiment of a message comprising a license agreement for attached files.

FIG. 6 is a schematic diagram of an exemplary embodiment of a menu comprising options for displaying attached files.

FIG. 7 is a schematic diagram of an exemplary embodiment of a storage medium implementing a file protection method.

### DETAILED DESCRIPTION

File protection methods and systems are provided.

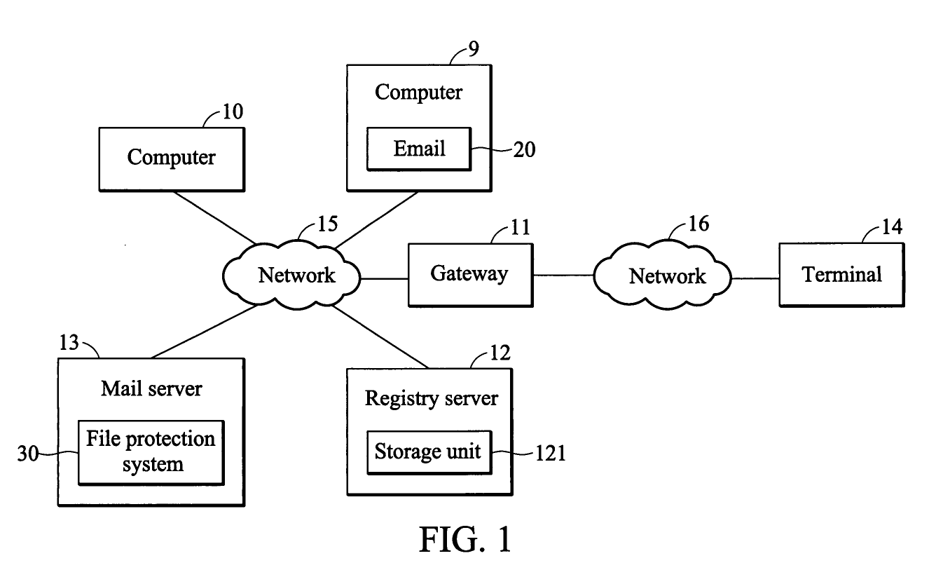

In FIG. 1, computers 9 and 10, gateway 11, registry server 12, and mail server 13 are coupled to network 15. Gateway 11 is coupled to terminal 14 through network 16. Networks 15 and 16 may respectively comprise a local area network (LAN) and the Internet. Note that configuration of these entities in FIG. 1 may be modified.

Mail server 13 comprises system 30 implementing a file protection method. Computer 9 composes email 20 to-be sent to a group of recipients and attaches files thereto. For example, email 20 is to be sent to computer 10 and terminal 14. Terminal 14 may be a personal computer, server, cell phone, pager, personal digital assistant (PDA), or laptop.

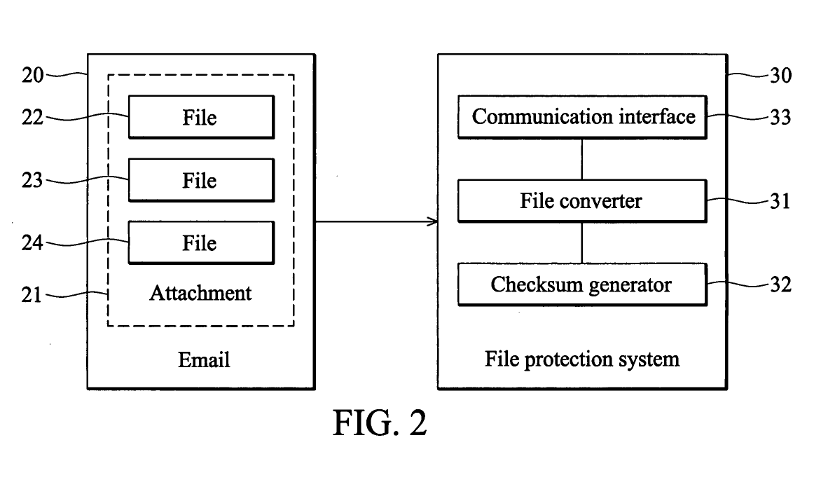

With reference to FIG. 2, email 20 comprises attachment 21, including files 22˜24 which may respectively conform to different data formats and require different corresponding applications when opened. For example, files 22˜24 may be various documents or images with extensions of .doc, .ppt, .pdf, .jpg, .bmp, gif, tif, or others.

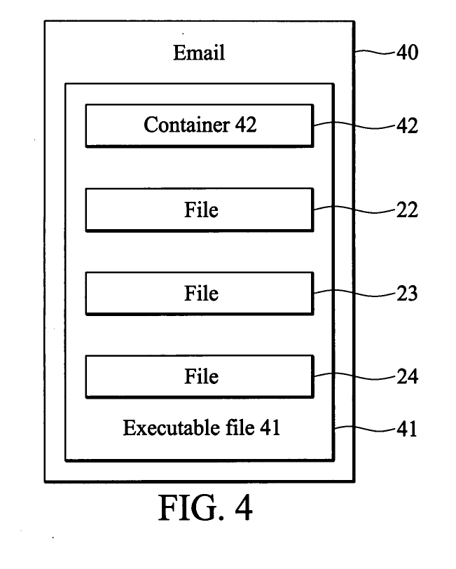

With reference to FIGS. 1 and 2, when submitted from computer 9, email 20 is routed to mail server 13. Server 13 receives and stores email 20 (step S2). Communication interface 31 in system 30 retrieves email 20 (step S4). File converter 32 automatically extracts files 22˜24 and makes executable file 41 (shown in FIG. 4) therefrom (step S6). For each of the files 22˜24, checksum generator 33 calculates a checksum thereof utilizing a particular algorithm and embeds the checksum in the file (step S7). The checksum helps in identifying the owner of the files.

With reference to FIG. 4, executable file 41 comprises files 22˜24 and container 42 for displaying content of files 22˜24 utilizing the display functions of the corresponding applications thereof. File converter 32 automatically generates email 40 and attaches executable file 41 thereto (step S8).

Several methods can be utilized to generate email 40. For example, file converter 32 may automatically substitute attachment 21 in email 20 by executable file 41 to transform email 20 into email 40. Alternatively, file converter 32 may automatically extract and write content of email 20 to a new email attached with executable file 41 to generate email 40.

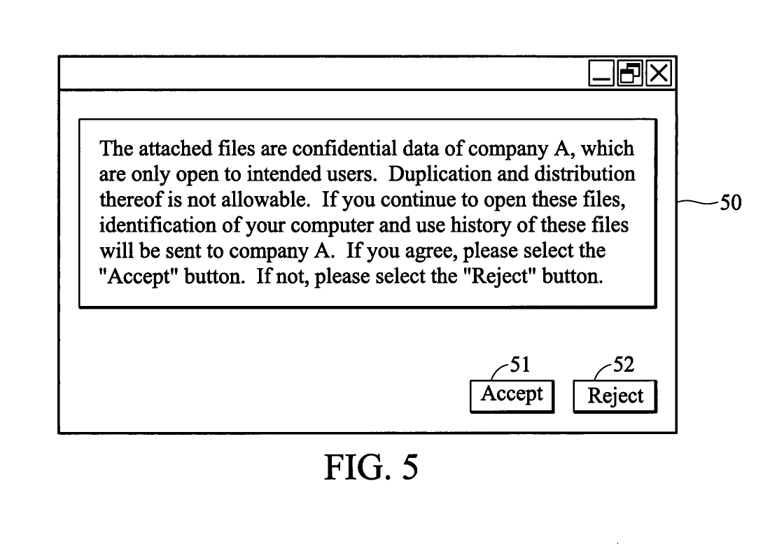

Communication interface 31 transmits e-mail 40 to the group of recipients (such as computer 10 and terminal 14). For example, terminal 14 receives email 40 (step S10) and executes executable file 41. Executable file 41 automatically displays a license agreement message for files 22˜24, indicating that recipient identification and use history of the attached files are to be submitted (step S12). For example, content of message 50 in FIG. 5 is as the following:

“The attached files are confidential data of company A, which are only open to intended users. Duplication and distribution thereof is not allowable. If you continue to open these files, identification of your computer and use history of these files will be sent to company A. If you agree, please select the “Accept”-button. If not, please select the “Reject” button.”

Executable file 41 provides control buttons 51 and 52 corresponding to agree and disagree for message 50, and triggering corresponding signals when selected.

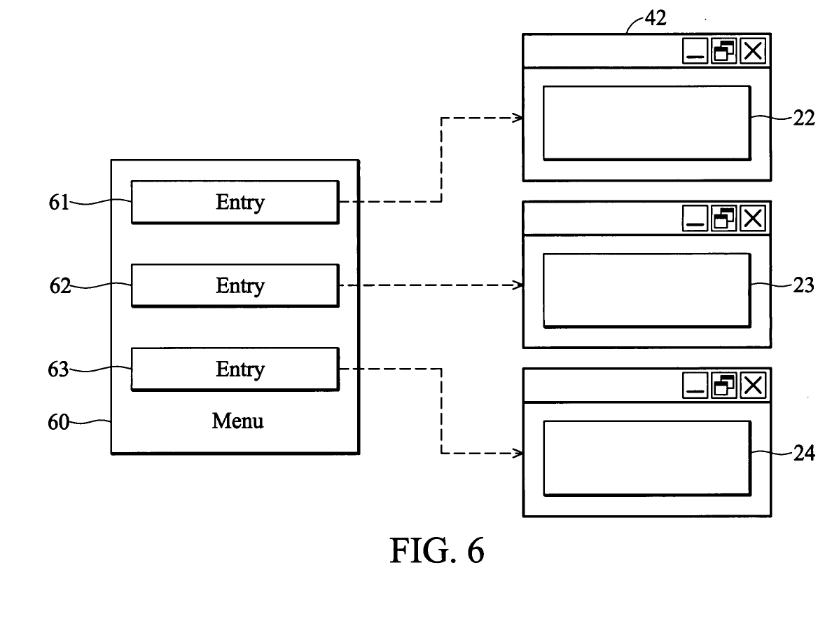

Executable file 41 receives a corresponding signal (step S14) and determines which button is selected (step S16). Upon receiving a signal corresponding to the “Reject” button, executable file 41 is terminated. Upon receiving a signal corresponding to the “Accept” button, executable file 41 displays menu 60 with entries 61˜63 corresponding to files 22˜24, as shown in FIG. 6 (step S18). When an entry (such as entry 61) is selected (step S20), executable file 41 automatically transmits the recipient identification, access time, the file name, and a checksum of a file (such as file 22) corresponding to the entry to the predetermined registry server 12 (step S22). The recipient identification may comprise Internet Protocol (IP) addresses extracted from email 40 by executable file 41, media access control (MAC), a combination thereof, or others.

Executable file 41 determines if the transmission is successfully completed (step S24). If not, executable file 41 determines if the transmission time exceeds a threshold number or a predetermined time (step S25). If so, executable file 41 is terminated. If not, executable file 41 performs step S24 again.

As shown in FIG. 6, if the transmission is successfully completed, executable file 41 displays container 42 with content of the corresponding file (such as file 22) therein. Rather than launching a corresponding application required to process content of the file, container 42 displays the content of the file in container 42 utilizing the essential component objects of the corresponding application and prevents implementation of other functions thereof, such as copy, print, and save operations (step S26).

The essential component objects may be embedded in executable file 41 in advance by file converter 32. Alternatively, executable file 41 can invoke essential component objects stored on the recipient host, a remote server, or others. Executable file 41 blocks commands duplicating the opened file to prevent the commands from being granted.

Registry server 12 receives the recipient identification, access time, file name, and the checksum 10 from the terminal 14 and stores the data in storage unit 121 coupled thereto. Thus, registry server 12 records and traces access to files 22˜24. Registry server 12 may comprises a database storing identification of authorized recipients, automatically determine if a recipient using attached files is authorized by comparing received recipient identification with records of the database, and issues an alert when the recipient is unauthorized.

Mail server 13 receives e-mails from source terminals within network 15 and automatically performs the file protection method for each of the e-mails. Note that conversion of email attachments can be implemented in other entities. For example, a computer may perform a similar file protection method on e-mails or files before transmission thereof. For example, computer 9 may comprise system 30 and convert email 20 to email 40 before delivery thereof through network 15.

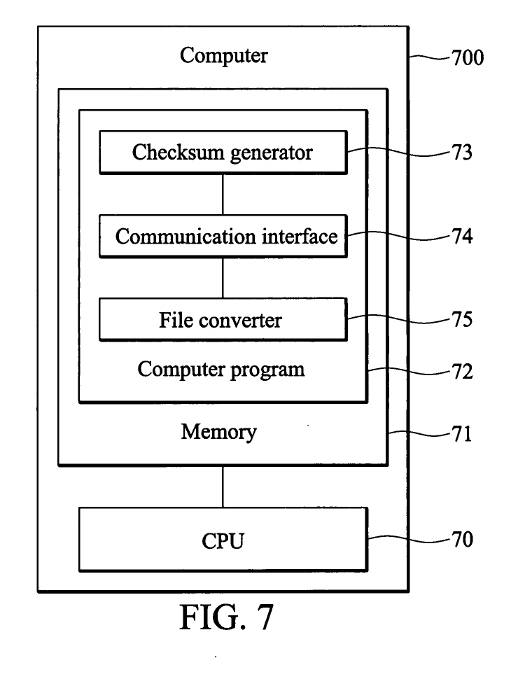

The file protection system can be implemented in computer programs or electronic circuits. For example, the file protection system is implemented in computer program 72 in FIG. 7, executable by central processing unit (CPU) 70 and stored in memory 71. When loaded into a computer 700, the file protection system directs the computer to perform a file protection method. Checksum generator 73 generates checksum of attached files. Communication interface 74 receives and transmits emails. File converter 75 converts attached files into an executable file performing the described steps.

In conclusion, when opening files attached to an email, a recipient terminal automatically determines whether to display the files based on transmission of the recipient terminal identification, file names, access time, file checksum and other information to a predetermined registry server. Use of attached files can be traced and well managed utilizing the predetermined registry server.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A file protection method, comprising:
retrieving at least one file attached to an e-mail;
automatically generating an executable file including the attached file;
automatically replacing the file attached to the e-mail with the executable file; and
transmitting the e-mail to a destination terminal, wherein, when executed, the executable file determines whether to display the attached file based on transmission of the destination terminal identification to a predetermined server.

2. The method as claimed in claim 1, wherein, after completing transmission of the destination terminal identification to the predetermined server, rather than utilizing an application required to process content of the file, the executable file displays the content of the file utilizing only the essential component objects of the application required to display content of the file.

3. The method as claimed in claim 2, wherein the executable file prevents implementation of copy, print, and save operations for the file.

4. The method as claimed in claim 3, wherein the executable file comprises a plurality of attached files associated with different applications and component objects of the applications required to display the attached files, further comprising after transmission of the destination terminal identification is completed, displaying a menu with options for triggering presentation of the attached files.

5. The method as claimed in claim 1, wherein whether the file is able to be shown further depends whether a file name thereof or access time of the attached file is transmitted from the destination terminal.

6. The method as claimed in claim 1, further comprising:
generating a checksum of the file utilizing a particular algorithm;
storing the checksum of the file in the executable file; and
wherein whether the file is able to be shown further depends on whether the checksum thereof is transmitted from the destination terminal.

7. The method as claimed in claim 1, wherein the method is implemented by a mail server coupled to a network, further comprising:
receiving the e-mails from source terminals coupled to the network; and
automatically performing the file protection method for each of the e-mails.

8. The method as claimed in claim 1, further comprising:
displaying a license agreement message for the attached file, that the destination terminal identification is to be transmitted;
providing control options of agreement and disagreement on the message; and
upon selection of the option of agreement, transmitting the destination terminal identification to the predetermined server.

9. A file protection method, comprising:
retrieving at least one file attached to an e-mail, which, when opening, requires an application for processing content thereof;
automatically generating an executable file including the attached file; and
automatically replacing the file attached to the e-mail by the executable file, wherein when the executable file is executed, rather than launching the application, the executable file displays the content of the attached file utilizing essential component objects performing display functions of the application, wherein the executable file prevents implementation of other functions of the application for the file.

10. The method as claimed in claim 9, wherein the executable file prevents implementation of copy, print, and save operations for the file.

11. The method as claimed in claim 9, wherein the executable file comprises a plurality of attached files associated with different applications and component objects of the applications required to display the attached files, and the executable file displaying a menu with options for triggering presentation of the attached files.

12. The method as claimed in claim 9, further comprising:
generating a checksum of the file utilizing a particular algorithm;
storing the checksum of the file in the executable file, wherein whether the file is able to be shown depends on whether the checksum thereof is transmitted to a predetermined server.

13. A file protection system, comprising:
a communication interface retrieving at least one file attached to an e-mail;
a file converter automatically generating an executable file including the attached file and automatically replacing the file attached to the e-mail by the executable file, wherein the communication interface transmits the e-mail to a destination terminal, when executed, the executable file determines whether to display the attached file based on transmission of the destination terminal identification to a predetermined server.

14. The system as claimed in claim 13, wherein, after completing transmission of the destination terminal identification to the predetermined server, rather than utilizing an application required to processing content of the file, the executable file displays the content of the file utilizing the essential component objects of the application required to display content of the file.

15. The system as claimed in claim 14, wherein the executable file prevents implementation of copy, print, and save operations for the file.

16. The system as claimed in claim 15, wherein the executable file comprises a plurality of attached files associated with different applications and component objects of the applications required to display the attached files, and after transmission of the destination terminal identification is complete, displays a menu with options for triggering presentation of the attached files.

17. The system as claimed in claim 13, wherein whether the file is able to be shown further depends whether a file name thereof or access time of the attached file is transmitted from the destination terminal.

18. The system as claimed in claim 13, further comprising a checksum generator generating a checksum of the file utilizing a particular algorithm and storing the checksum of the file in the executable file, wherein whether the file is able to be shown further depends on whether the checksum thereof is transmitted from the destination terminal.

19. The system as claimed in claim 13, wherein the system comprises a mail server coupled to a network, receiving the e-mails from source terminals coupled to the network, and automatically performing the file protection system for each of the e-mails.

20. The system as claimed in claim 13, wherein the executable file displays a license agreement message for the attached file, that the destination terminal identification is to be transmitted, provides control options of agreement and disagreement on the message, and upon selection of the option of agreement, transmits the destination terminal identification to the predetermined server.
